(19) United States
(12) Patent Application Publication
(10) Pub. No.: US 2023/0131543 A1
(43) Pub. Date: Apr. 27, 2023

(54) APPARATUS AND METHOD WITH MULTI-TASK PROCESSING

(71) Applicants: Samsung Electronics Co., Ltd., Suwon-si (KR); Korea Advanced Institute of Science and Technology, Daejeon (KR)

(72) Inventors: Jun-Woo JANG, Suwon-si (KR); Jaekang SHIN, Daejeon (KR); Lee-Sup KIM, Daejeon (KR); Seungkyu CHOI, Daejeon (KR)

(73) Assignees: Samsung Electronics Co., Ltd., Suwon-si (KR); Korea Advanced Institute of Science and Technology, Daejeon (KR)

(21) Appl. No.: 17/903,969

(22) Filed: Sep. 6, 2022

(30) Foreign Application Priority Data
Oct. 26, 2021 (KR) 10-2021-0143670

(51) Int. Cl. G06N 3/04; G06V 10/82

(52) U.S. Cl. CPC G06N 3/0454; G06V 10/82

(57) ABSTRACT

A processor-implemented method with multi-task processing includes: obtaining weights of a first neural network; obtaining first delta weights of a second neural network that is fine-tuned from the first neural network, based on a target task; performing an operation of the second neural network on first input data, based on sums of the weights of the first neural network and the first delta weights; obtaining second delta weights of a third neural network that is fine-tuned from the first neural network, based on a change of the target task; replacing the first delta weights with the second delta weights; and performing an operation of the third neural network on second input data, based on sums of the weights of the first neural network and the second delta weights, wherein the first delta weights comprise difference values in the weights of the first neural network and weights of the second neural network, and the second delta weight comprises difference values in the weights of the first neural network and weights of the third neural network.

### CROSS-REFERENCE TO RELATED APPLICATIONS

This application claims the benefit under 35 USC § 119(a) of Korean Patent Application No. 10-2021-0143670, filed on Oct. 26, 2021, in the Korean Intellectual Property Office, the entire disclosure of which is incorporated herein by reference for all purposes.

### BACKGROUND

### 1. Field

The following description relates to an apparatus and method with multi-task processing.

### 2. Description of Related Art

Computer vision (CV) tasks may be implemented using deep neural networks (DNNs), and applications using DNNs may also be diversified. A DNN model for CV may be trained to process a single task. For image classification, for example, a DNN model may not be trained as a universal model for classifying classes of all objects, but rather may be trained to classify a set of classes selected for a predetermined purpose (e.g., to perform a single predetermined task) and the trained model may be referred to as a task-specific model. In general, a task-specific model may be trained through transfer learning that fine-tunes a base model that is pre-trained using a large volume of training data to a predetermined task. In this case, as the number of tasks increases, the number of task-specific models or the values of parameters may increase linearly. However, apparatuses and methods implementing a plurality of task-specific models may not efficiently store and load the plurality of task-specific models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method with multi-task processing includes: obtaining weights of a first neural network; obtaining first delta weights of a second neural network that is fine-tuned from the first neural network, based on a target task; performing an operation of the second neural network on first input data, based on sums of the weights of the first neural network and the first delta weights; obtaining second delta weights of a third neural network that is fine-tuned from the first neural network, based on a change of the target task; replacing the first delta weights with the second delta weights; and performing an operation of the third neural network on second input data, based on sums of the weights of the first neural network and the second delta weights, wherein the first delta weights comprise difference values in the weights of the first neural network and weights of the second neural network, and the second delta weight comprises difference values in the weights of the first neural network and weights of the third neural network.

The obtaining of the first delta weights may include: obtaining first compressed data stored corresponding to the second neural network; and obtaining the first delta weights by decoding the first compressed data.

The first compressed data may include metadata storing a position of a non-zero weight and a value of the non-zero weight, of the first delta weights.

The obtaining of the second delta weights may include: obtaining second compressed data stored corresponding to the third neural network; and obtaining the second delta weights by decoding the second compressed data.

The second compressed data may include metadata storing a position of a non-zero weight and a value of the non-zero weight, of the second delta weights.

The performing of the operation of the second neural network may include: restoring weights of one or more layers included in the second neural network, based on the sums of the weights of the first neural network and the first delta weights; and performing the operation of the second neural network on the first input data, based on the restored weights.

The performing of the operation of the third neural network may include: restoring weights of one or more layers included in the third neural network, based on the sums of the weights of the first neural network and the second delta weights; and performing the operation of the third neural network on the second input data, based on the restored weights.

In another general aspect, one or more embodiments include a non-transitory computer-readable storage medium storing instructions that, when executed by one or more processors, configure the one or more processors to perform any one, any combination, or all operations and methods described herein.

In another general aspect, an apparatus with multi-task processing includes: one or more processors configured to: obtain weights of a first neural network; obtain first delta weights of a second neural network that is fine-tuned from the first neural network, based on a target task; perform an operation of the second neural network on first input data, based on sums of the weights of the first neural network and the first delta weights; obtain second delta weights of a third neural network that is fine-tuned from the first neural network, based on a change of the target task; replace the first delta weights with the second delta weights; and perform an operation of the third neural network on second input data, based on sums of the weights of the first neural network and the second delta weights, wherein the first delta weights comprise difference values in the weights of the first neural network and weights of the second neural network, and the second delta weights comprise difference values in the weights of the first neural network and weights of the third neural network.

The apparatus may include a memory configured to store the weights of the first neural network, the first delta weights, and the second delta weights.

In another general aspect, an apparatus for multi-task processing includes: one or more processors configured to: obtain outputs of a first layer corresponding to a plurality of tasks related to a base model and weights of a second layer corresponding to the base model; and for each of the plurality of tasks, obtain delta weights of the second layer corresponding to the task; restore weights of the second layer corresponding to the task, based on the obtained delta weights and the weights of the second layer corresponding to the base model; and obtain outputs of the second layer corresponding to the task, based on outputs of the first layer corresponding to the task and the restored weights of the second layer, wherein the first layer is a previous layer of the second layer.

The apparatus may include a memory configured to store weights of one or more layers included in the base model and delta weights corresponding to the plurality of tasks.

The delta weights corresponding to the task may include difference values between weights of the base model and weights of a task-specific model obtained by fine-tuning the base model to the task.

The outputs of the second layer obtained respectively corresponding to the plurality of tasks may be input to a third layer that is a subsequent layer of the second layer.

For the obtaining of the delta weights, the one or more processors may be further configured to: obtain compressed data of weights stored corresponding to the task; and obtain the delta weights of the second layer corresponding to the task by decoding the compressed data.

In another general aspect, a processor-implemented method with multi-task processing may include: for each of a plurality of task-specific neural networks each fine-tuned from a same base neural network for a different task, obtaining delta weights of the task-specific neural network, the delta weights corresponding to differences between weights of the base neural network and weights of the task-specific neural network; restoring the weights of the task-specific neural network based on the weights of the base neural network and the delta weights; and performing an operation of the task-specific neural network on input data, using the restored weights.

For each of the task-specific neural networks, the delta weights may be determined by: determining the differences between the weights of the base neural network and the weights of the task-specific neural network; and determining the delta weights by performing either one or both of pruning and quantization on a result of the determining of the differences.

For each of the task-specific neural networks, the obtaining of the delta weights, the restoring of the weights, and the performing of the operation may be performed using one or more processors, and the obtaining of the delta weights may include decoding compressed data loaded from a memory external to the one or more processors.

The base neural network may be trained for image processing, and each of the task-specific neural networks may be trained for a different task among image depth estimation, image edge detection, image semantic segmentation, and image normal vector estimation.

Other features and aspects will be apparent from the following detailed description, the drawings, and the claims.

### BRIEF DESCRIPTION OF THE DRAWINGS

FIG. 1 illustrates an example of an operation of a processor for multi-task processing.

FIG. 2 illustrates an example of restoring weights of a neural network based on delta weights.

FIG. 3 illustrates an example of a method of processing multiple tasks by restoring a model obtained by fine-tuning a base model.

FIG. 4 illustrates an example of an operation of a processor for multi-task processing.

FIG. 5 illustrates an example of an operation of performing operations of an Lth layer respectively corresponding to two tasks in parallel in response to there being two tasks related to a base model.

FIG. 6 illustrates an example of a hardware structure of a processor for multi-task processing.

FIG. 7 illustrates an example of a portion of operations of a processor for multi-task processing.

FIG. 8 illustrates an example of a configuration of an apparatus including a processor for multi-task processing.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The terminology used herein is for the purpose of describing particular examples only and is not to be limiting of the present disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, integers, steps, operations, elements, components, numbers, and/or combinations thereof, but do not preclude the presence or addition of one or more other features, integers, steps, operations, elements, components, numbers, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

Unless otherwise defined, all terms used herein including technical or scientific terms have the same meaning as commonly understood by one of ordinary skill in the art to which examples belong after and understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

Hereinafter, examples will be described in detail with reference to the accompanying drawings. When describing the examples with reference to the accompanying drawings, like reference numerals refer to like elements and a repeated description related thereto will be omitted.

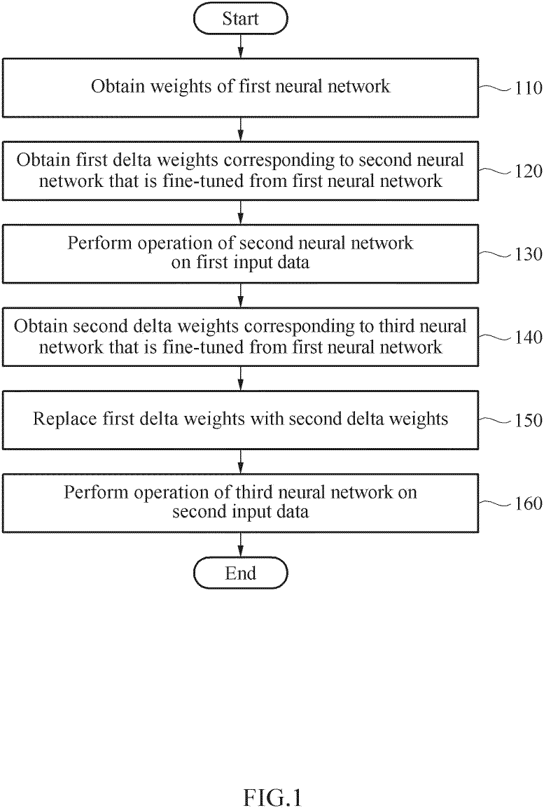

FIG. 1 illustrates an example of an operation of a processor for multi-task processing.

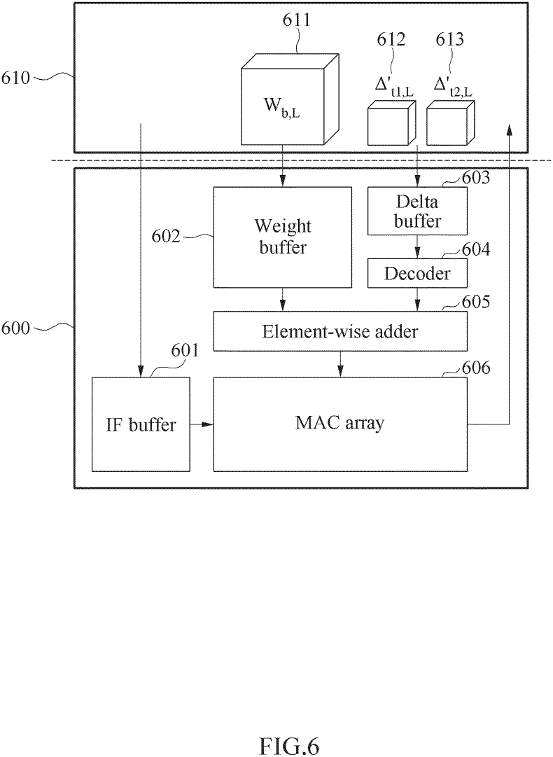

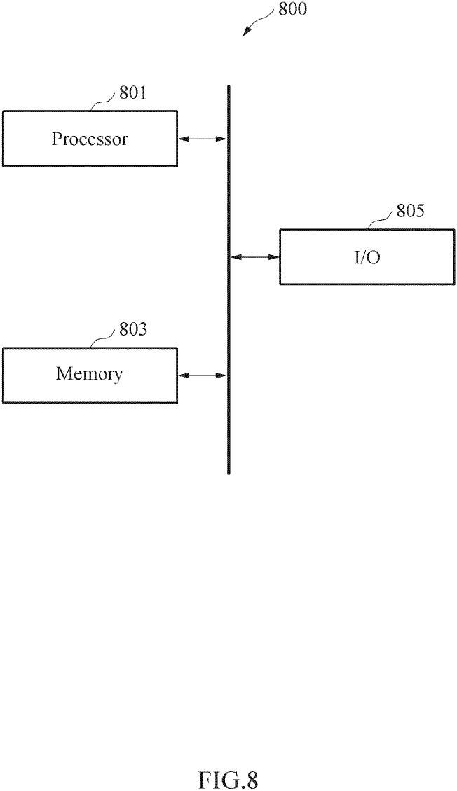

Referring to FIG. 1, an operating method of a processor (either one or both of a processor 600 of FIG. 6 and a processor 801 of FIG. 8, as non-limiting examples) for multi-task processing may include operation 110 of obtaining (e.g., determining) weights of a first neural network, operation 120 of obtaining first delta weights of a second neural network that is fine-tuned from the first neural network, operation 130 of performing an operation of the second neural network on first input data, operation 140 of obtaining second delta weights of a third neural network that is fine-tuned from the first neural network, operation 150 of replacing the first delta weights with the second delta weights, and operation 160 of performing an operation of the third neural network on second input data. The processor for multi-task processing may include a neural processing unit (NPU), for example, a neural processor. Hereinafter, the “processor for multi-task processing” may be simply referred to as the “processor”. A non-limiting example hardware structure of the processor for multi-task processing will be described in detail below.

Operation 110 may include obtaining the weights of the first neural network stored in a memory (either one or both of a memory 610 of FIG. 6 and a memory 803 of FIG. 8, as non-limiting examples). The first neural network may correspond to a pre-trained base model. Weights of a neural network may be parameters determined in a training process to obtain output data by transforming input data, and the weights of the first neural network may include weight(s) of layer(s) determined by pre-training. For example, when the first neural network is a convolution neural network (CNN), the weights of the first neural network may include filters or kernels corresponding to respective layers of the CNN.

The weights of the pre-trained first neural network may be stored in the memory, and the processor may load at least a portion of the weights of the first neural network from an external memory (e.g., the memory) to a buffer (a weight buffer 602 of FIG. 6, as a non-limiting example) in the processor or to a storage device directly accessible by the processor. The external memory may be a memory positioned outside the processor or a memory not accessible directly by the processor. The processor and the external memory may both be included in a same apparatus (an apparatus 800 of FIG. 8, as a non-limiting example). Hereinafter, as a non-limiting example, the external memory may be briefly referred to as the memory.

Operation 120 may include obtaining first delta weights of the second neural network that is fine-tuned from the first neural network based on a target task. The second neural network may be a network obtained by fine-tuning the first neural network to a target task, and may correspond to a task-specific model corresponding to the target task. The second neural network may include weights obtained by fine-tuning the weights of the first neural network based on training data for the target task.

The fine-tuning may include newly training the pre-trained first neural network based on training data for a predetermined purpose. For example, during the fine-tuning, a portion of layers of the first neural network may be replaced or updated, and the second neural network may be obtained by newly training the first neural network of which the portion of layers is replaced or updated. As another example, during the fine-tuning, a portion of the layers of the first neural network may be newly trained, or all the layers may be newly trained. The training data for a predetermined purpose used in fine-tuning may be at least partially different from the training data used in the training of the first neural network.

By fine-tuning the first neural network that is a base model, a plurality of task-specific models corresponding to a plurality of tasks including the second neural network and the third neural network may be obtained. For example, by fine-tuning a base model for image processing, a first model for estimating a depth of an image, a second model for detecting an edge in an image, a third model for semantic segmentation of an image, and a fourth model for estimating a normal vector of an image may be obtained, as non-limiting examples.

A target task may be a task corresponding to an operation to be processed by the processor, and delta weights to be obtained may be determined according to the target task. The target task may be given as an input. For example, when a first task is input, delta weights of a neural network obtained by fine-tuning the first neural network to the first task may be obtained, and when a second task is input, delta weights of a neural network obtained by fine-tuning the first neural network to the second task may be obtained. Delta weights may be stored in the memory, corresponding to a task of a corresponding neural network.

As described above, the second neural network may correspond to a neural network obtained by fine-tuning the first neural network to the target task, and based on an input target task, delta weights of the second neural network stored in the memory, corresponding to the target task, may be obtained. The delta weights of the second neural network may be referred to as first delta weights. The first delta weights obtained from the external memory may be loaded to the buffer of the processor.

The first delta weights may correspond to difference values between the weights of the first neural network and the weights of the second neural network. As an example, the first delta weights may be obtained by subtracting the weights of the first neural network from the weights of the second neural network obtained by fine-tuning the first neural network.

The first delta weights of the second neural network may be compressed and stored. As an example, first compressed data that are compressed data of the first delta weights may be stored corresponding to the second neural network in the external memory. For example, the first compressed data may include data obtained by compressing the first delta weights using pruning and/or quantization or metadata obtained by encoding positions and values of non-zero weights of the first delta weights. The metadata may be data including position information and values of non-zero delta weights of the delta weights, and may correspond to a small volume of data compared to all delta weights including zeros. Further, for example, the first compressed data may include data obtained by encoding data, obtained by compressing the first delta weights using pruning and/or quantization, into metadata. The values of the non-zero delta weights included in the metadata may correspond to quantized values.

Operation 120 may include obtaining first compressed data stored corresponding to the second neural network, and obtaining first delta weights by decoding the obtained first compressed data. The obtaining of the first compressed data may include loading the first compressed data stored corresponding to the second network in the external memory to the buffer of the processor. The decoding of the first compressed data may include restoring the first compressed data to the first delta data.

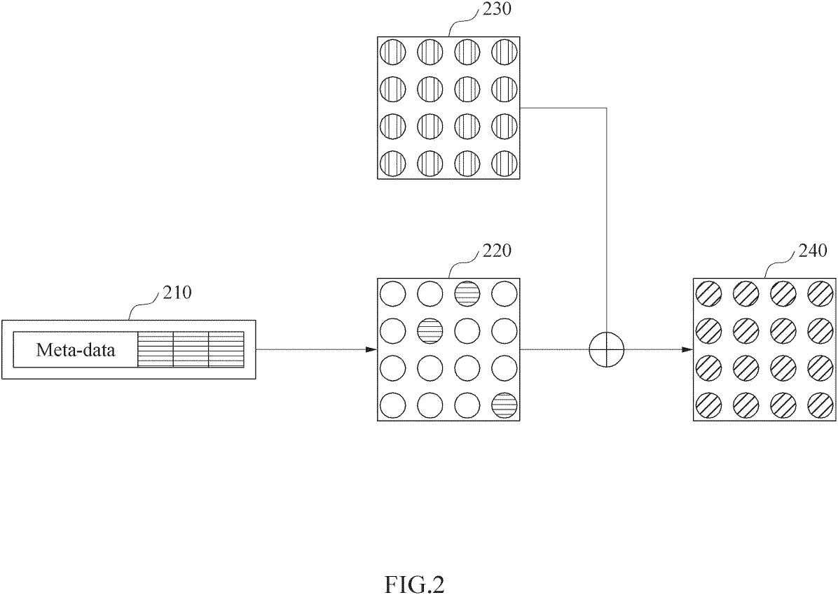

For example, referring to FIG. 2, metadata 210 corresponding to first compressed data may be restored to first delta weights 220 by decoding. Based on position information and values of non-zero first delta weights included in the metadata 210, the first delta weights 220 including the values of delta weights corresponding to the respective positions of the second neural network may be obtained. A non-limiting example of the decoding of the first compressed data will be described in detail below.

Operation 130 may include performing an operation of the second neural network on first input data, based on sums of the weights of the first neural network and the first delta weights. The weights of the second neural network may be obtained based on the sums of the weights of the first neural network obtained in operation 110 and the first delta weights obtained in operation 120.

For example, referring to FIG. 2, weights 240 of the second neural network may be obtained by adding the first delta weights 220 and weights 230 of the first neural network. When the weights correspond to a filter of a convolutional layer of a CNN, the weights 240 of the second neural network may be restored based on the sums of the first delta weights 220 and the weights 230 of the first neural network for each element of the filter.

Operation 130 may include restoring weights of at least one layer (e.g., one or more layers) included in the second neural network based on the sums of the weights of the first neural network and the first delta weights, and performing an operation of the second neural network on first input data based on the restored weights. For example, the processor may restore the weights of the second neural network by adding corresponding first delta weights and respective weights of at least one layer included in the first neural network, and perform an operation of the second neural network on the first input data based on the restored weights of the second neural network. The operation of the second neural network may include an operation based on the first input data and the weights of the second neural network, and may include an operation for obtaining an output of the second neural network corresponding to the first input data. For example, the processor may obtain a result of applying the first input data to the second neural network by performing the operation of the second neural network on the first input data.

Operation 140 may include obtaining second delta weights of the third neural network that is fine-tuned from the first neural network based on a change of the target task. In response to the target task being changed to another target task, delta weights of the third neural network stored corresponding to the other target task may be obtained. The third neural network may be a network obtained by fine-tuning the first neural network to the other target task, and may correspond to a task-specific model corresponding to the other target task. The third neural network may include weights obtained by fine-tuning the weights of the first neural network based on training data for the other target task. The delta weights of the third neural network may be referred to as second delta weights.

The second delta weights may correspond to difference values between the weights of the first neural network and the weights of the third neural network. As an example, the second delta weights may be obtained by subtracting the weights of the first neural network from the weights of the third neural network obtained by fine-tuning the first neural network.

Like the first delta weights, the second delta weights may be compressed and stored. As an example, second compressed data that are compressed data of the second delta weights may be stored corresponding to the third neural network in the external memory. Like the first compressed data, the second compressed data may include metadata storing positions and values of non-zero weights of the second delta weights, or include data obtained by encoding data, obtained by compressing the second delta weights using pruning and/or quantization, into metadata.

Operation 140 may include obtaining second compressed data stored corresponding to the third neural network, and obtaining second delta weights by decoding the obtained second compressed data. The decoding of the second compressed data may correspond to the decoding of the first compressed data.

Operation 150 may include storing the second delta weights instead of the first delta weights in the buffer of the processor. According to operation 150, the operation, performed by the processor, corresponding to the first delta weights may be replaced with an operation corresponding to the second delta weights.

Operation 160 may include performing an operation of the third neural network on the second input data based on sums of the weights of the first neural network and the second delta weights. As the first delta weights are replaced with the second delta weights in operation 150, the operation of operation 130 corresponding to the first delta weights may be performed corresponding to the second delta weights. For example, operation 160 may include restoring weights of at least one layer included in the third neural network based on the sums of the weights of the first neural network and the second delta weights, and performing an operation of the third neural network on the second input data based on the restored weights. The processor may obtain a result of applying the second input data to the third neural network by performing the operation of the third neural network on the second input data.

The processor may obtain a task-specific model for performing another task by replacing delta weights corresponding to a predetermined task while the weights of the first neural network being the base model are loaded, and obtain an output result according to an operation of the obtained task-specific model. The processor of one or more embodiments may only newly load delta weights (instead of loading the entire task-specific model or all weights of the task-specific model, for example) and thus, the processor of one or more embodiments may reduce a data loading time compared to a typical processor that loads the entire task-specific model or all weights of the task-specific model, and the processor of one or more embodiments thus may quickly load different task-specific models to process multiple tasks.

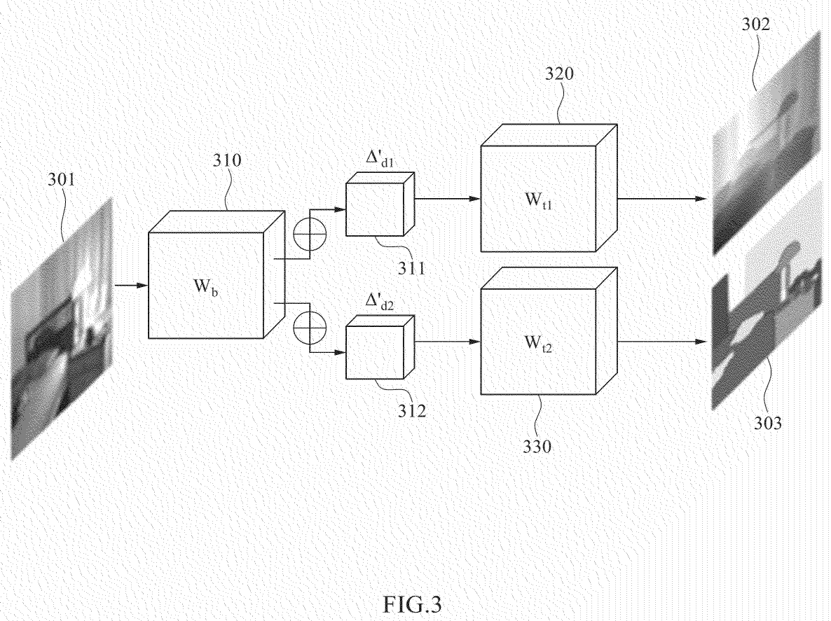

For example, referring to FIG. 3, when a request for a depth estimation task is received in a state in which weights 310 of a base model for image processing is loaded to a processor, delta weights 311 of a first task-specific model (which is a task-specific model for depth estimation) obtained by fine-tuning the base model to a depth estimation task may be loaded. Based on the weights 310 of the base model and the delta weights 311 of the first task-specific model, weights 320 of the first task-specific model may be restored. Based on the restored weights 320 of the first task-specific model, an operation of the task-specific model for depth estimation of an input image 301 may be performed, and a depth estimation result 302 for the input image 301 may be output. When a request for a segmentation task is received by the processor, delta weights 312 of a second task-specific model (which is a task-specific model for segmentation obtained by fine-tuning the base model to a segmentation task) may be loaded, and the delta weights 311 of the first task-specific model may be replaced with the delta weights 312 of the second task-specific model. Based on the weights 310 of the base model and the delta weights 312 of the second task-specific model, weights 330 of the second task-specific model may be restored. Based on the restored weights 330 of the second task-specific model, an operation of the second task-specific model for the input image 301 may be performed, and a segmentation result 303 for the input image 301 may be output.

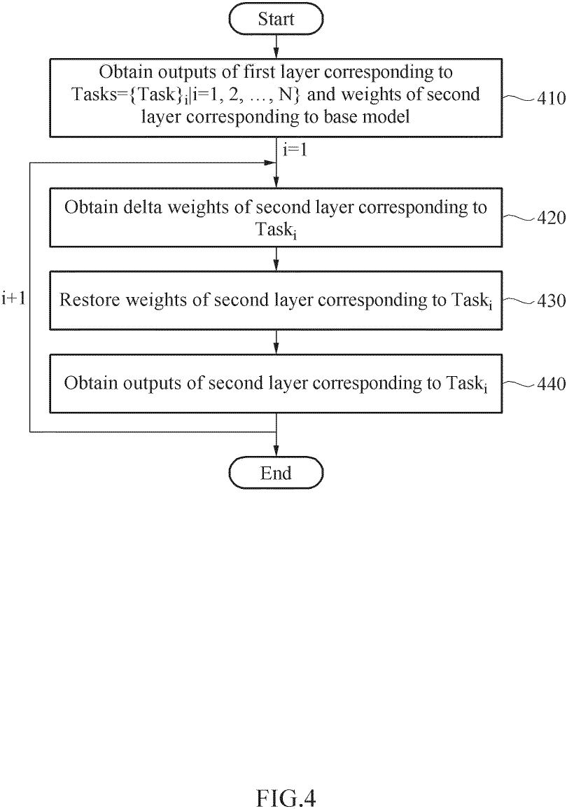

FIG. 4 illustrates an example of an operation of a processor for multi-task processing.

Referring to FIG. 4, an operating method of a processor for multi-task processing may include operation 410 of obtaining outputs of a first layer corresponding to a plurality of tasks (Tasks={Taskᵢ|i=1, 2, ..., N}) related to a base model and weights of a second layer corresponding to the base model, and for each of the plurality of tasks, operation 420 of obtaining delta weights of the second layer corresponding to the task Taskᵢ, operation 430 of restoring weights of the second layer corresponding to the task, and operation 440 of obtaining outputs of the second layer corresponding to the task. The first layer may correspond to a previous layer of the second layer, and for example, when the second layer is an L^{th} layer layer_{L}, the first layer may correspond to an L-1 ^{th} layer layer_{L-1}.

The plurality of tasks (Tasks={Taskᵢ|i=1, 2, ..., N}) may correspond to a plurality of task-specific models obtained by fine-tuning the base model. For example, if N=2, that is, when the number of tasks related to the base model is “2”, the number of task-specific models obtained by fine-tuning the base model may be “2”, and the task-specific models may respectively correspond to the two tasks.

Outputs of the first layer corresponding to the plurality of tasks may be outputs of the previous layer of the second layer corresponding to the plurality of tasks, and may include outputs of the first layer respectively corresponding to the plurality of tasks. The outputs of the first layer corresponding to the plurality of tasks may be obtained by operation 440 performed corresponding to the first layer.

When the second layer is the first, the obtaining of the outputs of the first layer corresponding to the plurality of tasks may include obtaining input data.

As described above, the base model may include a pre-trained neural network, and weights of a layer included in the base model may be stored in the memory. The processor may load the weights of the second layer corresponding to the base model from the memory to the buffer in the processor.

Delta weights corresponding to a predetermined task may include difference values between the weights of the base model and weights of a task-specific model obtained by fine-tuning the base model to the task. For example, delta weights of the second layer corresponding to a predetermined task may correspond to delta weights of the second layer included in a task-specific model corresponding to the task, obtained by fine-tuning the base model to the task.

Operation 420 may include loading the delta weights of the second layer corresponding to the task Taskᵢ from the memory to the buffer in the processor. As described above, the delta weights may be compressed and stored in the memory, and compressed data obtained by compressing the delta weights may be loaded to the buffer in the processor. As an example, the compressed data may include metadata storing positions and values of non-zero delta weights of the delta weights corresponding to the task Taskᵢ. The compressed data may be restored to the delta data by a decoding process. For example, operation 420 may include obtaining compressed data of weights stored corresponding to the task Taskᵢ, and obtaining the delta weights of the second layer corresponding to the task Taskᵢ by decoding the compressed data.

Operation 430 may include restoring the weights of the second layer corresponding to the task Taskᵢ, based on the obtained delta weights and the weights of the second layer corresponding to the base model. For example, the processor may restore the weights of the second layer corresponding to the task Taskᵢ, by adding the delta weights obtained in operation 420 and the weights of the second layer corresponding to the base model, obtained in operation 410.

Operation 440 may include obtaining outputs of the second layer corresponding to the task Taskᵢ, based on the outputs of the first layer corresponding to the task Taskᵢ, and the restored weights of the second layer. The processor may receive the outputs of the first layer corresponding to the task Taskᵢ, obtained in operation 410, as inputs of the second layer, and obtain the outputs of the second layer corresponding to the task Taskᵢ by applying the restored weights of the second layer corresponding to the task Taskᵢ, thereto.

For each of the plurality of tasks, the outputs of the second layer obtained by performing operations 420 to 440 may be input to a third layer that is a subsequent layer of the second layer.

Operations 420 to 440 may correspond to performing an operation on the second layer for each of the plurality of tasks. Operations 420, 430, and 440 corresponding to each task may be performed in parallel or sequentially for the plurality of tasks. For example, the processor may process operations 420, 430, and 440 corresponding to Taskᵢ, and operations 420, 430, and 440 corresponding to Task₂ at the same time, or perform operations 420, 430, and 440 corresponding to Taskᵢ, and then operations 420, 430, and 440 corresponding to Task₂.

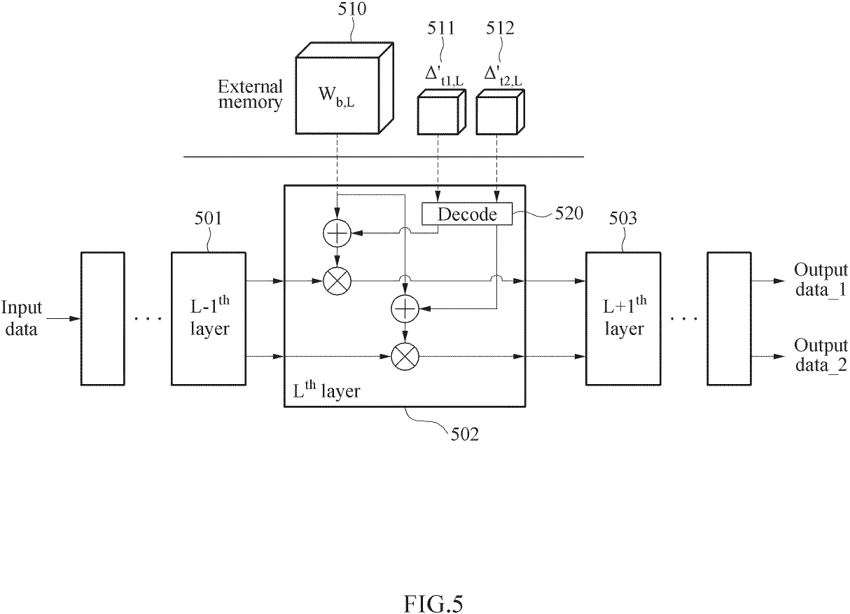

For example, FIG. 5 illustrates an operation of performing operations of an L^{th} layer respectively corresponding to two tasks in parallel in response to there being two tasks related to a base model.

Referring to FIG. 5, weights 510 of an L^{th} layer 502 of the base model may be loaded from a memory, and delta weights 511 of the L^{th} layer 502 corresponding to a first task and delta weights 512 of the L^{th} layer 502 corresponding to a second task may be loaded in parallel. The loaded delta weights 511 and 512 may correspond to compressed data, and the compressed data may be decoded by the processor in operation 520. The decoded delta weights corresponding to the first task and the weights of the base model may be added, whereby the weights of the L^{th} layer 502 corresponding to the first task may be restored. The decoded delta weights corresponding to the second task and the weights of the base model may be added, whereby the weights of the L^{th} layer 502 corresponding to the second task may be restored. The operation of decoding the compressed delta weights and adding the decoded delta weights and the weights of the base model will be described in detail below.

By converting outputs of an L-1 ^{th} layer 501, which is a previous layer of the L^{th} layer 502, corresponding to each task based on the weights of the L^{th} layer 502 restored corresponding to each task, outputs of the L^{th} layer 502 corresponding to each task may be obtained. The outputs of the L^{th} layer 502 corresponding to each task may be used as inputs of an L+1 ^{th} layer 503, which is a subsequent layer. In order to perform a plurality of tasks, the weights of the base model may be loaded once, and compressed delta weights corresponding to each task may be loaded, such that it is possible to reduce the loading time for operations and process the plurality of tasks in parallel.

FIG. 6 illustrates an example of a hardware structure of a processor for multi-task processing.

Referring to FIG. 6, a processor 600 may include an input feature (IF) buffer 601, a weight buffer 602, a delta buffer 603, a decoder 604, and an element-wise adder 605, and a multiply and accumulation (MAC) array 606 The processor 600 may further include a communication interface, and may transmit and receive data to and from the memory 610 and/or an input/output (I/O) interface through the communication interface.

The memory 610 may be an external memory positioned outside of the processor 600, and may include, for example, a storage device that is provided in an apparatus including the processor 600 and not accessible directly by the processor 600, and a memory or cloud memory of an external device connected to the apparatus including the processor 600 through a network. The memory 610 may store weights 611 of a base model and compressed delta weights 612 and 613 of task-specific models obtained by fine-tuning the base model. The memory 610 may store a result of performing an operation on a layer by the processor 600. In addition, the memory 610 may store data related to the operation of the processor for multi-task processing described above with reference to FIGS. 1 to 5, for example, data necessary for processing multiple tasks in the processor and/or data generated during the process of performing the operation of processing multiple tasks in the processor.

The IF buffer 601 may be a buffer for storing input features, and may store output data of a previous layer obtained from the memory 610 or input data corresponding to the task-specific models received through the I/O interface. The IF buffer 601 may transfer the stored data to the MAC array 606 such that a MAC operation based on the weights may be performed.

The weight buffer 602 may be a buffer for storing the weights of the base model obtained from the memory 610, and may load and store at least a portion of the weights of the base model. For example, the buffer 602 may load and store weights of a layer currently performing an operation, of the weights of the base model, and in the case of a CNN, may load and store a filter of a layer currently performing an operation.

The delta buffer 603 may be a buffer for loading and storing delta weights corresponding to task-specific models from the memory 610, and may load and store delta weights of at least one task-specific model corresponding to the base model or at least a portion of compressed data of the delta weights. For example, the delta buffer 603 may load and store delta weights of a layer currently performing an operation, of the delta weights of the task-specific model. The delta weights stored in the delta buffer 603 may include compressed delta weights, and the compressed delta weights may be decoded by a decoder 604.

The decoder 604 may perform decoding the compressed data of the delta weights stored in the delta buffer 603 such that an operation between the decoded data and the weights of the base model stored in the weight buffer 602 may be performed. For example, the decoder 604 may perform outputting delta weights corresponding to respective positions of the weights of the base model stored in the weight buffer 602, based on position information of non-zero delta weights included in metadata stored in the delta buffer 603 as the compressed data of the delta weights.

The element-wise adder 605 may perform adding the loaded weights of the base model and the corresponding delta weights elementwise. In the case of a CNN, the element-wise adder 605 may add a filter corresponding to the weights of the base model and a filter corresponding to the delta weights, by elements at the same position.

The MAC array 607 may perform a MAC operation, for example, a matrix multiplication operation and a convolution operation. The outputs of the MAC array 607 may be stored in the memory 610 and used for an operation of a subsequent layer, or may be output as a final operation result through the I/O interface.

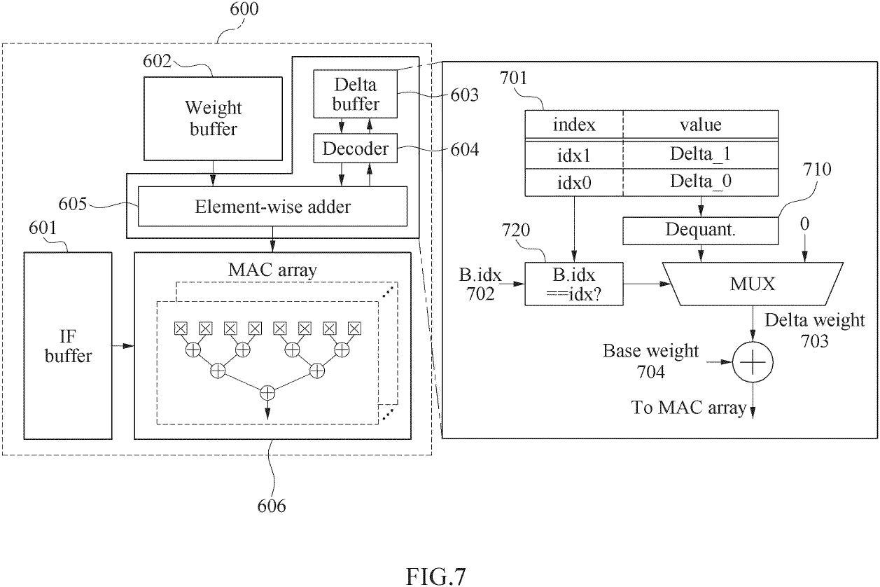

FIG. 7 illustrates an example of a portion of operations of a processor for multi-task processing. A processor 600 of FIG. 7 may correspond to the processor 600 described above with reference to FIG. 6.

Referring to FIG. 7, the delta buffer 603 of the processor 600 may store metadata 701 that are compressed data of delta weights corresponding to a predetermined task. The decoder 604 may output delta weights 703 corresponding to input weights of the base model by decoding the metadata 701 based on indices 702 of the input weights of the base model. As described above, the values of the delta weights included in the metadata 701 may correspond to quantized values, and the decoder 604 may dequantize the quantized data in operation 710. The decoder 604 may determine whether the indices of the input weights of the base model are the same as the indices of the delta weights included in the metadata 701, in operation 720. When the indices are the same, the decoder 604 may output the value of dequantized delta weights corresponding to the indices, and when the indices are not the same, the decoder 604 may output “0”. The element-wise adder 605 may add weights 704 of the base model corresponding to a predetermined index that is input and delta weights 703 output from the decoder 604 corresponding to the index, and transfer values obtained as a result of the addition to the MAC array 606.

FIG. 8 illustrates an example of a configuration of an apparatus including a processor for multi-task processing.

Referring to FIG. 8, an apparatus 800 is a device for multi-task processing, and includes a processor 801 (e.g., one or more processors), a memory 803 (e.g., one or more memories), and an I/O device 805. The apparatus 800 may be or include, for example, a user device (e.g., a smartphone, a personal computer (PC), a tablet PC, etc.) and a server.

The processor 801 may be or include the processor (e.g., the processor 600 of FIG. 6 and/or the processor 600 of FIG. 7) for multi-task processing described above with reference to FIGS. 1 to 7. In other words, the processor for multi-task processing described above may be included in the apparatus 800 for multi-task processing. The processor 801 may perform any one, any combination of any two or more, or all operations and methods described above with reference to FIGS. 1 to 7.

The memory 803 may correspond to a memory (e.g., the memory 610 of FIG. 16) for storing the weights of the base model and the weights of at least one task-specific model obtained by fine-tuning the base model described above. As described above, the memory 803 may store data related to the operation of the processor for multi-task processing described above with reference to FIGS. 1 to 7, for example, data necessary for processing multiple tasks in the processor and/or data generated during the process of performing the operation of processing multiple tasks in the processor.

The weights of the base model and the weights of at least one task-specific model obtained by fine-tuning the base model may be stored in a memory positioned outside of the apparatus 800. In this case, the apparatus 800 may further include a communication interface for communicating with the memory in which the weights are stored. The weights of the base model and the weights of at least one task-specific model obtained by fine-tuning the base model, obtained from the memory positioned outside, may be stored in the memory 803 of the apparatus 800.

The apparatus 800 may be connected to an external device (e.g., a PC or a network) through the I/O device 805 to exchange data with the external device. For example, the apparatus 800 may receive input data through the I/O device 805 and output data obtained by the operation of the processor 801.

The memory 803 of the apparatus 800 may store a program in which the operating method of the processor for multi-task processing described above with reference to FIGS. 1 to 5 is implemented, and the processor 801 may execute the program stored in the memory 803 and control the apparatus 800. The memory 803 may be or include a non-transitory computer-readable storage medium storing instructions that, when executed by the processor 801, configure the processor 801 to perform any one, any combination of any two or more, or all operations and methods described above with reference to FIGS. 1 to 7.

The processors, memories, IF buffers, weight buffers, delta buffers, decoders, element-wise adders, MAC arrays, apparatuses, I/O devices, processor 600, memory 610, IF buffer 601, weight buffer 602, delta buffer 603, decoder 604, element-wise adder 605, MAC array 606, apparatus 800, processor 801, memory 803, I/O device 805, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented method with multi-task processing, the method comprising:
obtaining weights of a first neural network;
obtaining first delta weights of a second neural network that is fine-tuned from the first neural network, based on a target task;
performing an operation of the second neural network on first input data, based on sums of the weights of the first neural network and the first delta weights;
obtaining second delta weights of a third neural network that is fine-tuned from the first neural network, based on a change of the target task;
replacing the first delta weights with the second delta weights; and
performing an operation of the third neural network on second input data, based on sums of the weights of the first neural network and the second delta weights,
wherein
the first delta weights comprise difference values in the weights of the first neural network and weights of the second neural network, and
the second delta weight comprises difference values in the weights of the first neural network and weights of the third neural network.

2. The method of claim 1, wherein the obtaining of the first delta weights comprises:
obtaining first compressed data stored corresponding to the second neural network; and
obtaining the first delta weights by decoding the first compressed data.

3. The method of claim 2, wherein the first compressed data comprises metadata storing a position of a non-zero weight and a value of the non-zero weight, of the first delta weights.

4. The method of claim 1, wherein the obtaining of the second delta weights comprises:
obtaining second compressed data stored corresponding to the third neural network; and
obtaining the second delta weights by decoding the second compressed data.

5. The method of claim 4, wherein the second compressed data comprises metadata storing a position of a non-zero weight and a value of the non-zero weight, of the second delta weights.

6. The method of claim 1, wherein the performing of the operation of the second neural network comprises:
restoring weights of one or more layers included in the second neural network, based on the sums of the weights of the first neural network and the first delta weights; and
performing the operation of the second neural network on the first input data, based on the restored weights.

7. The method of claim 1, wherein the performing of the operation of the third neural network comprises:
restoring weights of one or more layers included in the third neural network, based on the sums of the weights of the first neural network and the second delta weights; and
performing the operation of the third neural network on the second input data, based on the restored weights.

8. A non-transitory computer-readable storage medium storing instructions that, when executed by one or more processors, configure the one or more processors to perform the method of claim 1.

9. An apparatus with multi-task processing, the apparatus comprising:
one or more processors configured to:
obtain weights of a first neural network;
obtain first delta weights of a second neural network that is fine-tuned from the first neural network, based on a target task;
perform an operation of the second neural network on first input data, based on sums of the weights of the first neural network and the first delta weights;
obtain second delta weights of a third neural network that is fine-tuned from the first neural network, based on a change of the target task;
replace the first delta weights with the second delta weights; and
perform an operation of the third neural network on second input data, based on sums of the weights of the first neural network and the second delta weights, wherein
the first delta weights comprise difference values in the weights of the first neural network and weights of the second neural network, and
the second delta weights comprise difference values in the weights of the first neural network and weights of the third neural network.

10. The apparatus of claim 9, further comprising:
a memory configured to store the weights of the first neural network, the first delta weights, and the second delta weights.

11. An apparatus for multi-task processing, the apparatus comprising:
one or more processors configured to:
obtain outputs of a first layer corresponding to a plurality of tasks related to a base model and weights of a second layer corresponding to the base model; and for each of the plurality of tasks,
obtain delta weights of the second layer corresponding to the task;
restore weights of the second layer corresponding to the task, based on the obtained delta weights and the weights of the second layer corresponding to the base model; and
obtain outputs of the second layer corresponding to the task, based on outputs of the first layer corresponding to the task and the restored weights of the second layer, wherein the first layer is a previous layer of the second layer.

12. The apparatus of claim 11, further comprising:
a memory configured to store weights of one or more layers included in the base model and delta weights corresponding to the plurality of tasks.

13. The apparatus of claim 11, wherein the delta weights corresponding to the task comprise difference values between weights of the base model and weights of a task-specific model obtained by fine-tuning the base model to the task.

14. The apparatus of claim 11, wherein the outputs of the second layer obtained respectively corresponding to the plurality of tasks are input to a third layer that is a subsequent layer of the second layer.

15. The apparatus of claim 11, wherein, for the obtaining of the delta weights, the one or more processors are further configured to:
obtain compressed data of weights stored corresponding to the task; and
obtain the delta weights of the second layer corresponding to the task by decoding the compressed data.

16. A processor-implemented method with multi-task processing, the method comprising:
for each of a plurality of task-specific neural networks each fine-tuned from a same base neural network for a different task,
obtaining delta weights of the task-specific neural network, the delta weights corresponding to differences between weights of the base neural network and weights of the task-specific neural network;
restoring the weights of the task-specific neural network based on the weights of the base neural network and the delta weights; and
performing an operation of the task-specific neural network on input data, using the restored weights.

17. The method of claim 16, wherein, for each of the task-specific neural networks, the delta weights are determined by:
determining the differences between the weights of the base neural network and the weights of the task-specific neural network; and
determining the delta weights by performing either one or both of pruning and quantization on a result of the determining of the differences.

18. The method of claim 16, wherein, for each of the task-specific neural networks,
the obtaining of the delta weights, the restoring of the weights, and the performing of the operation are performed using one or more processors, and
the obtaining of the delta weights comprises decoding compressed data loaded from a memory external to the one or more processors.

19. The method of claim 16, wherein
the base neural network is trained for image processing, and
each of the task-specific neural networks is trained for a different task among image depth estimation, image edge detection, image semantic segmentation, and image normal vector estimation.
